(19) United States
(12) Patent Application Publication
(10) Pub. No.: US 2012/0069582 A1
(43) Pub. Date: Mar. 22, 2012

(54) CEILING LAMP

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/300,629

(22) Filed: Nov. 20, 2011

Related U.S. Application Data
(66) Substitute for application No. 12/857,578, filed on Aug. 17, 2010, now abandoned.

(51) Int. Cl. F21V 21/00; F21V 29/00

(52) U.S. Cl. 362/371

(57) ABSTRACT

A ceiling lamp includes a bracket fixed to a ceiling, a frame attached to the bracket, a housing secured to the frame and a light source received in the housing. An axis extends through the frame and the bracket to pivotably attach the bracket with the frame. A plurality of apertures are defined in the bracket and an aperture is defined in the frame. A fastener can be selectively extended through one of the apertures in the bracket and into the aperture in the frame, to thereby position the housing at a selected one of different orientations in respect to the ceiling.

### BACKGROUND

1. Technical Field

The present disclosure relates to a ceiling lamp, and more particularly, to a ceiling lamp having various illumination orientations.

2. Description of Related Art

As indispensable objects widely used in people's daily life, lamps nowadays are developed to more and more different types according to the exact environments where they are applied, including road lamp, tunnel lamp, underwater lamp, landscape lamp, parking lamp, vehicle lamp, washing lamp, ceiling lamp, traffic lamp, table lamp, mine lamp, etc. For most of these types, such as ceiling lamp, the illumination orientations thereof are fixed as soon as being mounted in the corresponding environments, failing to provide more flexible and versatile illumination as desired.

What is needed, therefore, is a ceiling lamp which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an exemplary view of a ceiling lamp of the present disclosure.

FIG. 2 is an exploded view of the ceiling lamp of FIG. 1.

FIG. 3 shows the ceiling lamp of FIG. 1 mounted on a ceiling.

FIG. 4 is similar to FIG. 3, wherein the ceiling lamp has a different illumination orientation from that shown in FIG. 3.

### DETAILED DESCRIPTION OF THE EMBODIMENTS

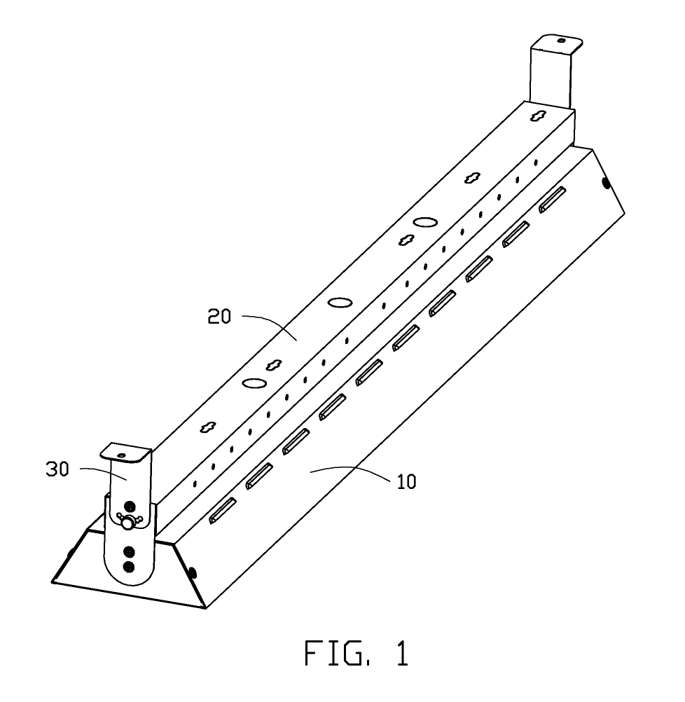

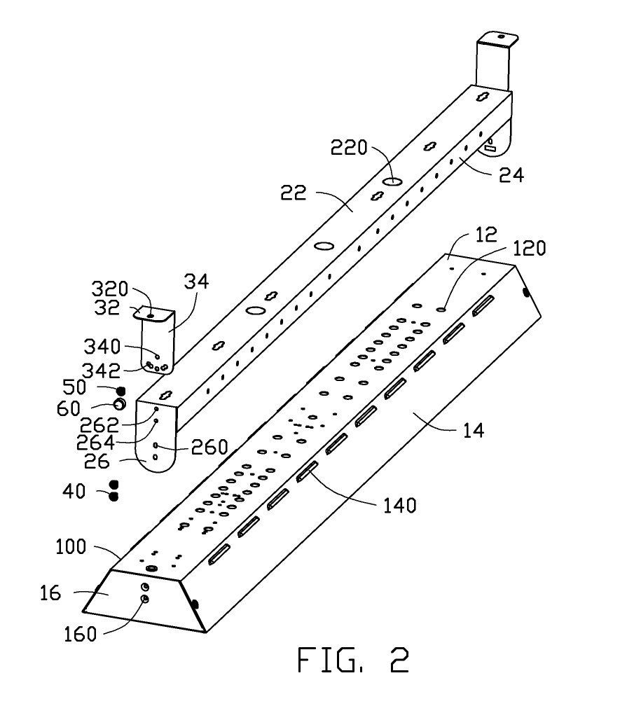

Referring to FIGS. 1-3, a ceiling lamp of the present disclosure is shown. The ceiling lamp includes a lamp body 10, a frame 20 fixed on the lamp body 10 and a pair of brackets 30 mounted to two opposite sides of the frame 20 and attached to a ceiling 70. The lamp body 10 includes a housing 100 and a light source (not shown) received therein. The light source may be a fluorescent tube, an incandescent bulb, multiple LEDs or other suitable light sources. The housing 100 is made of metal with sufficient strength. The housing 100 includes a top plate 12, a pair of side plates 14 extending downwardly and inclinedly from opposite right and left sides of the top plate 12, and a pair of covers 16 extending downwardly and perpendicularly from opposite front and rear sides of the top plate 12, respectively. The top plate 12 is rectangular and defines multiple holes 120 therein. Some of the holes 120 are for allowing wires (not shown) to extend therethrough to enter the housing 100 and connect with the light source, and the other holes 120 function as air passages for dissipating heat from an interior of the housing 10 to the ambient atmosphere. The pair of side plates 14 each define an angle about 120 degrees with the top plate 12. Each plate 14 has a plurality of slots (not labeled) defined adjacent to the top plate 12 for facilitating heat dissipation of the housing 100. The slots are aligned with each other in a line from the front side to the rear side of the housing 100 and at the left/right side of the top plate 12. Each side plate 14 forms a baffle plate 140 at a top edge of each slot for preventing surrounding dust from directly falling into the housing 100 through the slots. Each cover 16 interconnects the top plate 12 and the two side plates 14. Each cover 16 defines two holes 160 near the top plate 12 for engagingly receiving screws 40 therein.

The frame 20 includes a top wall 22, a pair of side walls 24 extending downwardly and perpendicularly from opposite left and right sides of the top wall 22, and a pair of arms 26 extending downwardly and perpendicularly from opposite front and rear sides of the top wall 22, respectively. The top wall 22 defines a plurality of apertures 220 for allowing the wires to extend out of the frame 20 from the housing 100. Each arm 26 has a rectangular upper portion interconnecting the top wall 22 and the two side walls 24, and a semicircular lower portion extending downwardly beyond the two opposite side walls 24. The lower portion of each arm 26 has two holes 260 defined therein for extension of the screws 40 through the arm 26 into the holes 160 of the cover 16, thereby to secure the housing 100 to the frame 20. The upper portion of each arm 26 has a hole 262 near the top wall 22 and an aperture 264 below the hole 262.

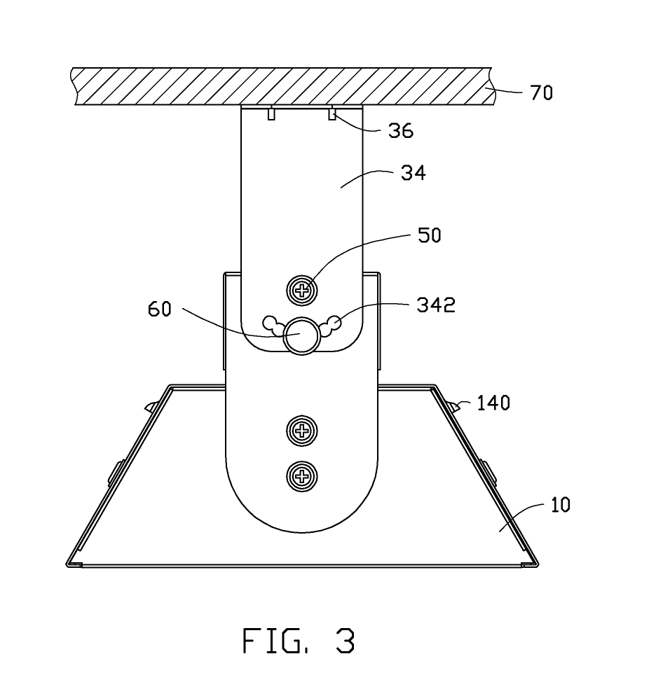

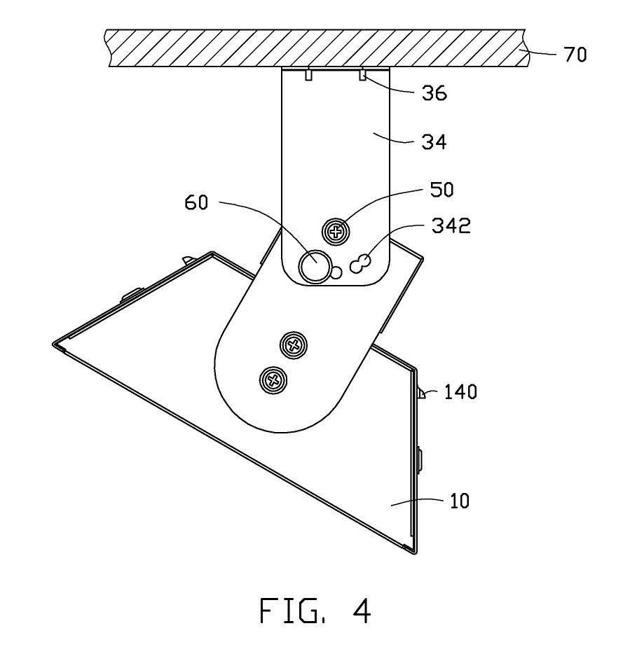

Also referring to FIG. 4, each bracket 30 includes a sheet 34 and a flange 32 extending perpendicularly and horizontally from a top of the sheet 34. The flange 32 defines a hole 320 therein for extending a screw (not shown) through the bracket 30 into the ceiling 70, thereby securing the bracket 30 to the ceiling 70 at a position below the ceiling 70. The sheet 34 defines a hole 340 neighboring a bottom thereof and multiple apertures 342 below the hole 340. The hole 340 in the sheet 34 is in alignment with the hole 262 in the upper portion of the arm 26 of the frame 20 so that an axis 50 can extend through the sheet 34 and the arm 26 to pivotably attach the frame 20 to the bracket 30. The apertures 342 are arranged in a curved manner that levels of the apertures 342 are gradually raised from a middle towards two laterals of the apertures 342. A screw 60 can be selectively extended through one of the apertures 342 into the aperture 264 in the arm 26, thereby to fix the frame 20 together with the housing 100 to the bracket 30 with a selected orientation. For example, the screw 60 can extend though a lowest aperture 342 of the bracket 30 to position the housing 100 to face vertically downwardly as shown in FIG. 3, whereby the ceiling lamp can project vertically downward light on a place just therebelow. The screw 60 can also extend through another aperture 342 adjacent to the lowest aperture 342 of the bracket 30 to position the housing 100 to face downwardly and inclinedly as shown in FIG. 4, whereby the ceiling lamp can project downward and inclined light on another place.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. A ceiling lamp comprising:
a housing configured for receiving a light source therein;
a frame fixed to the housing; and
a bracket pivotably attached to the frame and fixed to a ceiling;
wherein the bracket has a plurality of apertures at different levels; and
wherein a fastener is selectively extended through one of the apertures of the bracket and into the frame, to thereby secure the frame and accordingly the housing to the bracket with a required orientation.

2. The ceiling lamp as claimed in claim 1, wherein the frame is pivotable relative to the bracket around an axis, the apertures being located below the axis.

3. The ceiling lamp as claimed in claim 2, wherein the apertures are arranged in a curved manner that the apertures are gradually raised from a middle towards two laterals of the apertures.

4. The ceiling lamp as claimed in claim 1, wherein the frame comprises a top wall and an arm extending downwardly from the top wall, the bracket being pivotably attached to the arm.

5. The ceiling lamp as claimed in claim 4, wherein the arm comprises an upper portion and a lower portion, the axis extending through the upper portion of the arm, and the lower portion of the arm being fixed to the housing.

6. The ceiling lamp as claimed in claim 5, wherein the frame further comprises a pair of side walls extending downwardly from the top wall, the upper portion of the arm interconnecting the top wall and the two side walls and the lower portion of the arm extending downwardly beyond the two sidewalls.

7. The ceiling lamp as claimed in claim 1, wherein the housing has a plurality of slots aligned with each other.

8. The ceiling lamp as claimed in claim 7, wherein each of the slots has a baffle plate formed at a top edge thereof.

9. A ceiling lamp comprising:
a bracket secured to a ceiling;
a frame; and
a housing fixed to the frame and configured for receiving a light source therein;
wherein an axis extends through the frame and the bracket so that the frame is rotatable relative to the bracket around the axis; and
wherein a plurality of apertures are defined in the bracket, and an additional aperture is defined in the frame, the additional aperture of the frame can be aligned with each of the plurality of apertures of the bracket during rotation of the frame relative to the bracket so that a fastener could extend through the bracket into the frame to lock the bracket with the frame at a selected one of different positions.

10. The ceiling lamp as claimed in claim 9, wherein the plurality of apertures are located below the axis.

11. The ceiling lamp as claimed in claim 10, wherein the plurality of apertures are arranged in a curve which has two laterals higher than a middle thereof.

12. The ceiling lamp as claimed in claim 9, wherein the bracket comprises a flange connected to the ceiling and a sheet extending perpendicularly and downwardly from the flange, the plurality of apertures being defined in the sheet.

13. The ceiling lamp as claimed in claim 12, wherein the frame comprises a top wall parallel to the flange and an arm extending downwardly and perpendicularly from the top wall, the additional aperture being defined in the arm.

14. The ceiling lamp as claimed in claim 13, wherein the frame further comprises a pair of side walls extending downwardly from two opposite sides of the top wall, the arm having an upper portion coupling with the two side walls and a lower portion extending beyond the two side walls to connect with the housing.

15. The ceiling lamp as claimed in claim 14, wherein the housing comprises a top plate, a pair of side plates extending inclinedly and downwardly from two opposite sides of the top plate, and a pair of covers extending downwardly and perpendicularly from other two opposite sides of the top plate, the arm of the frame being connected to one of the pair of covers.

16. The ceiling lamp as claimed in claim 15, wherein each of the side plates has a plurality of slots aligned in a line and a plurality of baffle plates formed adjacent to the slots, respectively.

17. The ceiling lamp as claimed in claim 15, wherein a plurality of holes are defined in the top plate of the housing for heat dissipation.
